(19) United States
(12) Patent Application Publication
(10) Pub. No.: US 2017/0140320 A1
(43) Pub. Date: May 18, 2017

(54) SYSTEM AND METHODS FOR ANALYZING BUSINESS DATA

(71) Applicants: Michael R. English, Wheaton, IL (US); Vladimir Dragosavljevic, Arlington Heights, IL (US); Misha Kostich, Lisle, IL (US)

(72) Inventors: Michael R. English, Wheaton, IL (US); Vladimir Dragosavljevic, Arlington Heights, IL (US); Misha Kostich, Lisle, IL (US)

(21) Appl. No.: 15/353,973

(22) Filed: Nov. 17, 2016

Related U.S. Application Data
(63) Continuation of application No. 14/092,464, filed on Nov. 27, 2013, now abandoned.
(60) Provisional application No. 61/730,620, filed on Nov. 28, 2012.

(51) Int. Cl. G06Q 10/06; G06F 17/30

(52) U.S. Cl. CPC G06Q 10/06375; G06F 17/30595; G06F 17/30592; G06F 17/30477; G06Q 50/20

(57) ABSTRACT

Disclosed are a system and methods for analyzing business data. The system and methods may present users with a number of platforms that allow users to analyze aggregated business data, to view forecasts provided by the system, and to collaborate with other users. Analyzing business data may involve running queries and customizing visuals based on the business data, which may be aggregated in a comprehensive database or several databases. Forecasting may involve the use of linear regression lines that can be computed according to customized queries, visuals, and other user input. Further, users may collaborate over the system by sharing visuals, sharing queries, discussing hot topics, blogging, joining groups, and the like.

### CROSS-REFERENCE TO RELATED APPLICATION

This application is a continuation of co-pending application Ser. No. 14/092,464 filed Nov. 27, 2013, entitled SYSTEM AND METHODS FOR ANALYZING BUSINESS DATA which was a regular filing of U.S. provisional application No. 61/730,620, filed Nov. 28, 2012.

### TECHNICAL FIELD

The present disclosure relates generally to a system and methods for analyzing business data, and more specifically, the present invention relates to a system and methods for analyzing financial business data of schools and school districts for purposes of comparing, forecasting, and collaborating on the business data.

### BACKGROUND

Much like corporations, local governments of all types, sizes, and means operate on budgets. Funding for municipal budgets can occur in a number of ways. For example, many local governments rely on taxation for funding. Local governments also receive grants on occasion from other branches of government for particular projects or services. In addition, many local governments fund budgets through borrowing money. Local governments typically sell municipal bonds to investors in a public market. In some cases, these bonds may be issued by other branches of government, such as a state government or a special purpose district.

Needless to say, local governments must manage their budgets and resources wisely. Managing a budget for a local government, though, is easier said than done. Complexities are introduced due, for example, to variable spending and fluctuations in funding, such as where large deposits are made after a local government generates money through the sale of bonds. Further, local governments struggle with the challenge of balancing budgets with the services that their communities need and expect. Governance boards are routinely confronted with questions like how much to spend, where to spend it, and whether to invest for growth.

Of the many different services and projects that need to be funded, arguably, none are more important than those funds earmarked for the school districts and the schools themselves. In today's financial environment however, schools, for example, are under constant pressure to increase academic performance, which requires officials to allocate resources properly.

As a further example, cities and towns, must maintain service levels while identifying opportunities for business growth. County governments, which run highly complex businesses with disparate service mandates ranging from health services to public safety, face many similar decisions.

Local governments are able to review the budgets of other municipalities, as that information is publicly available. Likewise, administrators of schools and school districts have school information available to be reviewed. However, the problem is that the published information of local governments and schools is virtually unusable to the various administrators. It is difficult for officials to locate and review budgets of other school districts based, for instance, on total student enrollment. An official can compare other local governments' numbers one by one, but oftentimes this process is laborious as officials are not aware of another municipality, let alone several, that have attributes resembling their own.

Therefore, a long felt need exists for a system and methods that allow officials, both governmental and school administrators, to prepare reports based on selected data, review the reports, collaborate with others when necessary and thereafter budget and allocate resources based on the data obtained from other municipalities and other schools having similar attributes to their own.

### SUMMARY

The present invention provides a system and methods that allow local governments and school administrators to use selected data, collaborate about the data and generated reports to synchronize financial resources and strategic plans. Schools, cities, counties, and other municipalities, for instance, can utilize the system and methods to accelerate insight, increase field of vision, identify efficiencies, and capitalize on opportunities. The system and methods may be said to combine powerful financial applications with a next-generation collaboration platform to generate actionable analytics that help drive decisions for enhanced performance and service delivery.

The system and methods may involve a plurality of platforms, with each platform providing a different function. In one embodiment, for example, the system and methods may involve a review platform, a forecasting platform, a consultation platform, and a collaboration platform. Any one of these platforms will provide municipalities and school administrators with insight on resource management and allocation. Use of all these platforms, however, will provide municipalities and school administrators with the most insight.

The review platform may involve a multidimensional database containing millions of data records. The database may be intermittently or even constantly updated depending upon the frequency with which further or revised data becomes available. The data records may be cleansed and optimized to enable users to perform rapid queries of large data sets. Cleansing and optimization in turn allows users to filter data to a desired view, export data to spreadsheet applications or other platforms, compare peers, or view trends, for example. Further, the review platform can generate meaningful visuals. For instance, users can direct the platform to build a catalog of interactive data visualizations; to customize views of charts, dashboards, and maps; to filter data; and to update visuals immediately.

The forecasting platform involves quantitative analyses and financial projections that allow municipalities and school administrators to evaluate multiple complex scenarios in one database. For more customized projections, users can input unknowns based on criteria such as anticipated population growth or reductions in funding, for example. Moreover, the forecasting platform allows school administrators, officials and governing boards to make well-informed, data-driven decisions and to present a financial plan in a clear, concise way. By way of example, users can compare revenues with expenditures for upcoming years, or can compare expenditures across education, maintenance, and transportation sectors for an upcoming timeframe.

The consultation platform makes professionals that are experts in the field available to users. Professionals can help users build custom data sets in the system that are directly accessible through the review platform, for example. The professionals can also assist with developing or honing financial projections in the projection platform. Likewise, the professionals are available for collaboration when needed and can generate virtual dashboards, reports, and presentations tailored to the needs of a school, school district or municipality.

In short, the collaboration platform brings users (and when necessary, professionals) together and provides a space for them to communicate with one another. For example, users can distribute data, share lessons learned, survey other school districts and municipalities, review articles, blog with colleagues, exchange ideas with others, publish visualizations, search for solutions, identify best practices, and so on. Some of this shared information may originate from other platforms of the system. Further, users can join groups and address the same problem or similar problems as a group.

Other objects and advantages of the present disclosure will become apparent to one having ordinary skill in the art after reading the specification in light of the drawing figures, however, the spirit and scope of the present disclosure should not be limited to the description of the embodiments contained herein.

### BRIEF DESCRIPTION OF THE DRAWINGS

The preferred embodiments of the invention will be described in conjunction with the appended drawings, which illustrate and do not limit the invention, where like designations denote like elements, and in which:

FIG. 1 is a block diagram view of an exemplary embodiment of a system for analyzing business data in accordance with the present invention.

FIG. 2 illustrates an exemplary interface portion and features of an embodiment of an analysis portion of a review platform of the system of FIG. 1 in accordance with the present invention.

FIG. 3 illustrates an exemplary interface portion and features of an embodiment of an analysis portion of a review platform of the system of FIG. 1 in accordance with the present invention.

FIG. 4 illustrates an exemplary interface portion and features of an embodiment of a visual portion of a review platform of the system of FIG. 1 in accordance with the present invention.

FIG. 5 illustrates an exemplary interface portion and features of an embodiment of a visual portion of a review platform of the system of FIG. 1 in accordance with the present invention.

FIG. 6 illustrates an exemplary interface portion and features of an embodiment of a visual portion of a review platform of the system of FIG. 1 in accordance with the present invention.

FIG. 7 illustrates an exemplary interface portion and features of an embodiment of a visual portion of a review platform of the system of FIG. 1 in accordance with the present invention.

FIG. 8 illustrates an exemplary interface portion of an embodiment of a collaboration platform of the system of FIG. 1 in accordance with the present invention.

FIG. 9 illustrates an exemplary interface portion of an embodiment of a collaboration platform of the system of FIG. 1 in accordance with the present invention.

FIG. 10 illustrates an exemplary interface portion of an embodiment of a collaboration platform of the system of FIG. 1 in accordance with the present invention.

### DETAILED DESCRIPTION

The present disclosure generally provides a system and methods for analyzing business data. Although the detailed description is with reference to a school administrator or educational context, it should be understood that the present disclosure is not limited to the educational context except as expressly set forth in the claims. Education provides merely an exemplary context in which to explain the various aspects of the present disclosure.

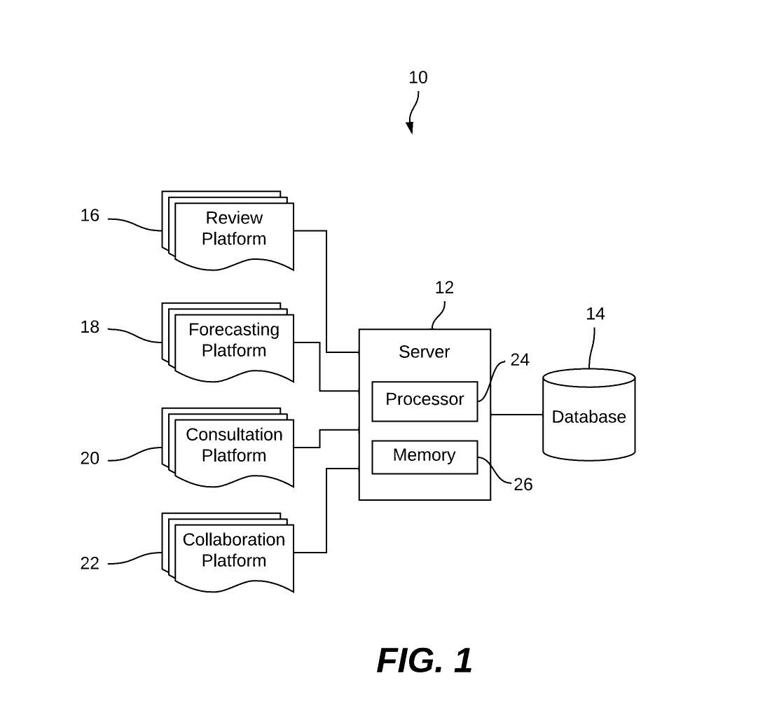

Referring to the figures, wherein like reference numerals indicate the same or similar elements in the various views, FIG. 1 is a block diagram view of an exemplary embodiment of a system 10 for analyzing business data. The system 10 may include a computer system, such as a server 12, in electronic communication with a database 14, and configured to provide a number of platforms. For example, the system may provide a review platform 16, a forecasting platform 18, a consultation platform 20, and a collaboration platform 22.

The server 12 may include a processor 24 and a non-transient computer-readable memory 26. The processor 24 may be configured to execute instructions (e.g., code) stored in the memory 26 to perform one or more operations described herein. For example, the memory 26 may contain instructions for providing one or more interfaces for the platforms 16, 18, 20, 22, performing computations on data, such as data in the database 14, and generating plots, charts, and tables representing the data. In some embodiments, the system 10 may utilize two or more computers, servers 12, network architectures, special- or general-purpose processors, mass storage devices, and the like. In other embodiments, though, the system 10 may operate on a single computer or electronic device.

A platform, as described herein, may comprise a user interface and underlying programming for performing the functionality of the platform. Each of the platforms 16, 18, 20, 22 may be accessible to one or more users for performing one or more operations. Each platform 16, 18, 20, 22 may serve a different purpose, as described below. The user interface for a platform may include, for example, one or more pages of a website, a portion of software as a service (SaaS), a portion of an online analytical processing (OLAP) application (e.g., relational online analytical processing (ROLAP), multidimensional online analytical processing (MOLAP)), in-memory processing, and/or a portion of a software program installed on a user's computer system.

The database 14 may include a multidimensional database and/or relational database and may have measure attributes and feature attributes, in an embodiment. In an embodiment, the database 14 may be or may include a SQL database, for example. Utilizing a multidimensional database may provide the ability for the system to rapidly process data and quickly generate responses to queries and user input. A multidimensional database or database portion may contain data organized by a number of dimensions, with hierarchies and levels within each dimension. In an embodiment, the database may include a single computing system or apparatus. In another embodiment, the database may include two or separate computing systems or apparatus.

The server 12 may be in electronic communication with the database 14 to read data from the database 14 and write data to the database 14. The system 10 (e.g., the server 12, or one or more users or administrators in electronic communication with the server 12) may aggregate business data from a variety of public sources, private sources, or a combination thereof and provide the data to the database. For example, the system 10 may aggregate data from census data, city, district, county, and/or state budgets, tax filings, and the like, and/or directly from the users of the system. The data may comprise, for example but without limitation, tax rates, tax collections, student academic test results, spending and budgets for schools, districts, counties, states, etc., population and demographic information, school enrollment information, and public fund investment information, to name a few of the many types of data that may be stored in the database 14.

The system 10 (e.g., through code stored in the memory) may be configured to cleanse data stored in the database 14. A number of procedures may be used for cleansing data. One such procedure, for example, may involve scanning data in the database for anomalies and inconsistencies such as, for example but without limitation, inconsistent descriptions of a city name (e.g., “LaCrosse,” “Lacrosse,” and “La crosse”) and correcting such anomalies and inconsistencies. Another exemplary procedure may involve configuring the system to calculate the deviations in data for a given school district from one year to the next. Where a deviation is considerably larger than a standard deviation within that category of data, the piece of data triggering the large deviation may be flagged for further review. This process may be used frequently, as the database can be updated on a rolling basis, in some embodiments.

The server 12 may provide the platforms 16, 18, 20, 22, through which one or more users may access data from and/or add data to the database 14. Thus, the server 12 may be configured (e.g., through code stored in the memory 26) to access the database 14 and provide the data in the database in one or more forms for viewing and manipulation by users.

Each platform 16, 18, 20, 22 may include one or more portions in which users can perform one or more operations. For example, the review platform 16 may include, for example but without limitation, an analysis portion through which a user can generally manipulate and query raw data, and a visual portion through which a user can generally request that the system 10 generate one or more charts, graphs, plots, etc. representative of particular portions of the data and/or view charts, graphs, plots, etc. representative of portions of data pre-determined by the system 10 to be particularly salient.

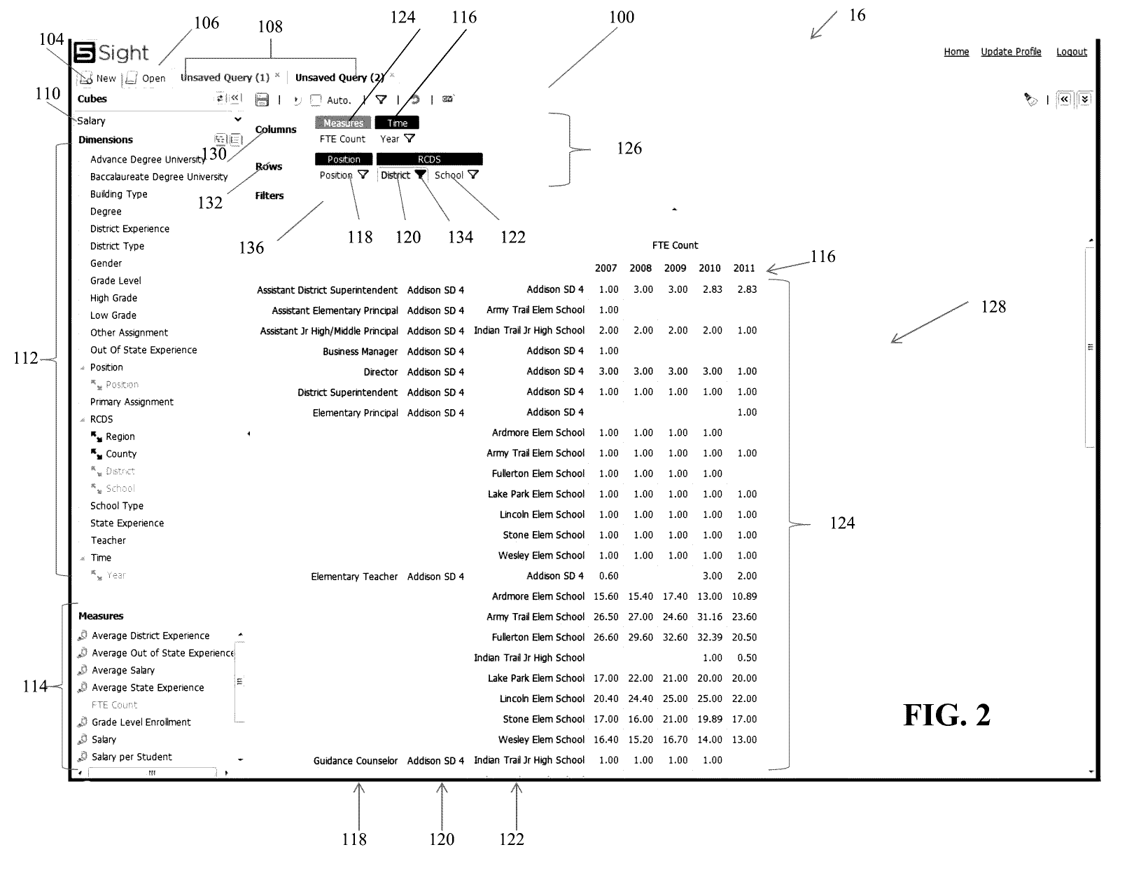

FIG. 2 illustrates an exemplary interface portion 100 for an analysis portion of the review platform 16. A user may navigate to the analysis portion of the review platform 16 to perform one or more queries on the database 14. In particular, the user may start a new query 104, open a saved query 106, or select one of any already-opened queries 108.

When starting a new query 104, the user may select a general topic from a dropdown box 110. The general topic may, in some embodiments, correspond to a “cube” of data (in multidimensional database terminology). The analysis portion may then display all dimensions 112 and measures 114 of data stored in the database 14 that pertain to the chosen general topic. Thus, the review platform 16 may be configured to format one or more user input prompts (e.g., drop-downs, radio buttons, check boxes, and the like) according to topics, dimensions 112, and measures 114, to receive user input, and to manipulate data for display to the user according to the user input. Likewise, dimensions and measures may correspond to features and measures, respectively, in multidimensional database terminology. In the example shown in FIG. 2, however, the business data being analyzed includes educational data, which may involve general topics such as salary, financial, enrollment, salary surveys, transportation, county metrics, and tax. The exemplary general topic in the illustrated dropdown box 110 here is “Salary.” The dimensions 112 and measures 114 thus may pertain to pieces of data in the database 14 that may relate to salaries of those employed in the field of education.

With continued reference to FIG. 2, the analysis portion of the review platform 16 shows that “Unsaved Query (2)” has been run. In this particular query, year 116, position 118, district 120, and school 122 have been selected as dimensions 112. A full-time equivalent (FTE) count 124 has been selected as the measure 114. It should be understood that users are not limited to selecting one measure 114 in a query. Other than the availability of data in the database 14, the only theoretical limitation in constructing a query is the workability and readability of output 128. Further, the FTE count 124 and the year 116 have been placed in columns 130, while position 118, district 120, and school 122 have been placed in rows 132. It should be further understood that the year 116 may be represented in terms of calendar year or fiscal year.

Each dimension 112 may have a subset of data that can either be used as input or selectively filtered. Looking to the district 120 dimension in the input 126, for example, a filter 134 is shown to be activated. The filter 134 may allow the user to select particular districts for which he or she would like to view output 128. As shown in FIG. 2, the user has selected “Addison SD 4”. Similar filters may exist for the other input 126, but are not activated in the illustrated example. For example, the database may have a subset of data available for the years 2007-2011, which may be filtered by year. In other embodiments, activated filters may appear in the “Filters” row 136.

The output 128 in this example is shown as FTE count 124 by year 116 for each position 118, district 120 (at least those selected in the filter 134), and school 122. If the user wishes to rearrange the order in which the output 128 appears, the user may simply reorder the dimensions 112 in the input 126.

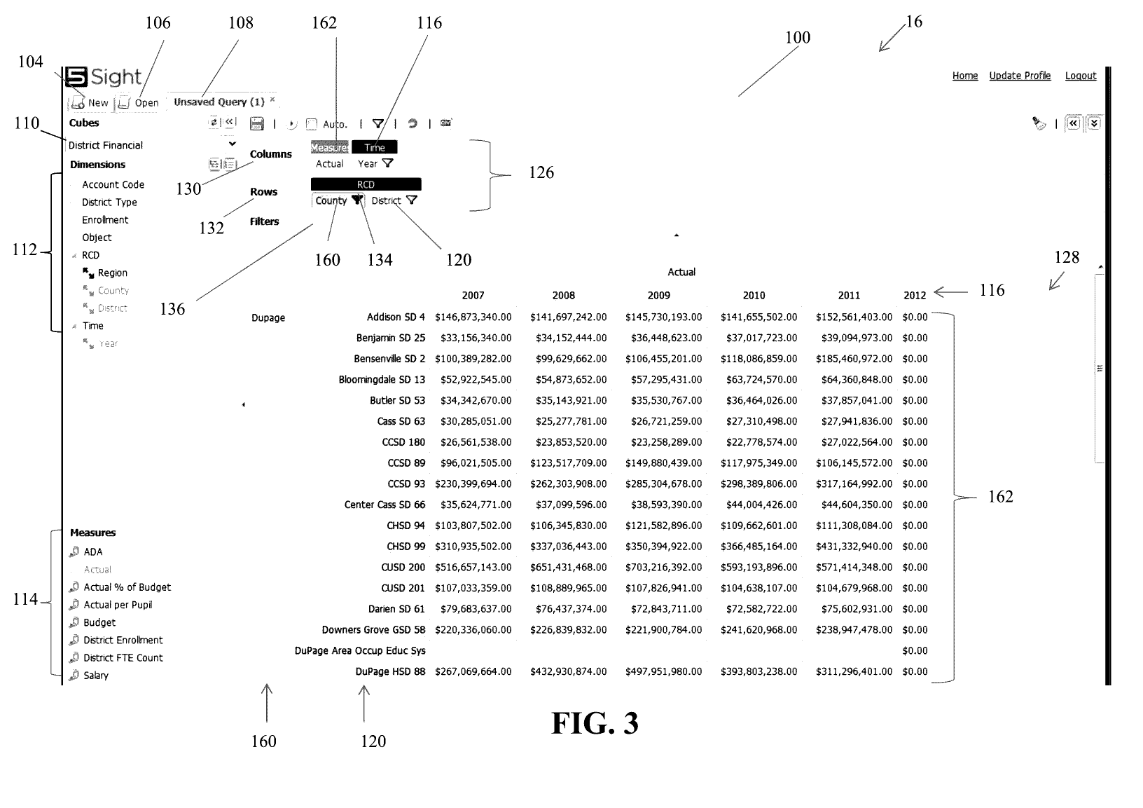

FIG. 3 illustrates another exemplary query in the interface portion 100 of the analysis portion of the review platform 16. In the illustrated query, the dropdown box 110 has been set to “District Financial.” The input 126 includes year 116, district 120, and county 160 as dimensions 112. The filter 134 on the county 160 input has been set to include at least those results from Dupage County as shown in the output 128. Actual expenditures 162 has been selected as a measure 114. Thus the output 128 shows actual expenditures 162 per year 116 by county 160 and school district 120.

As described above, the database may have a number of general topics within the dropdown box 110. To provide a better idea of the types of dimensions and measures within each general topic, several general topics are described further in a non-limiting manner. Under the topic of enrollment, for example, dimensions may include building type, district type, gender, grade level, low income, region, county, district, school, ethnicity, school type, and year. To further illustrate, measures under the enrollment topic may include gender enrollment, grade level enrollment, low income enrollment, ethnicity enrollment, and total enrollment. Similarly, under the topic of transportation, dimensions may include district type, expenditures, sub-expenditures, region, county, district, and year. Measures for transportation may include, without limitation, expenditures and expenditures per mile.

Moreover, a description of the general topics may accompany each general topic in the dropdown box 110. The description may also inform users from which sources certain data is collected. By way of example, the dropdown box 110 may indicate that the enrollment topic contains enrollment data by grade from the fall housing reports at the building and district level. As a further example, the financial topic may contain multiple years of budget and annual financial report data at the district level. Further yet, the transportation topic may contain transportation data from the annual transportation claim and the reimbursement computation.

The review platform 16 may also provide a multitude of data from which users may establish key performance indicators (e.g., for a particular school district, city, county, etc.). Key performance indicators may be used as part of processes that benchmark top-performing school districts, for example. Several merely exemplary key performance indicators may concern debt ratios, test scores, and emergency response times. Users may then compare key performance indicators of the top performers with statistics from their own districts, for instance.

Once a query is created, the system may use a graphics engine such as TABLEAU® Desktop and/or TABLEAU® Server, for instance, to generate visuals based on the query. From the output of the query, the graphics engine may provide a number of options and formats by which the user can customize the appearance of visuals that are generated. The resulting visual may be displayed in a visual portion of the review platform 102. The review platform 102 may have a “share” button (not shown) that allows the user to publish queries and visuals to his or her homepage. On the other hand, the user may export the output 128 to a spreadsheet and/or or some other format.

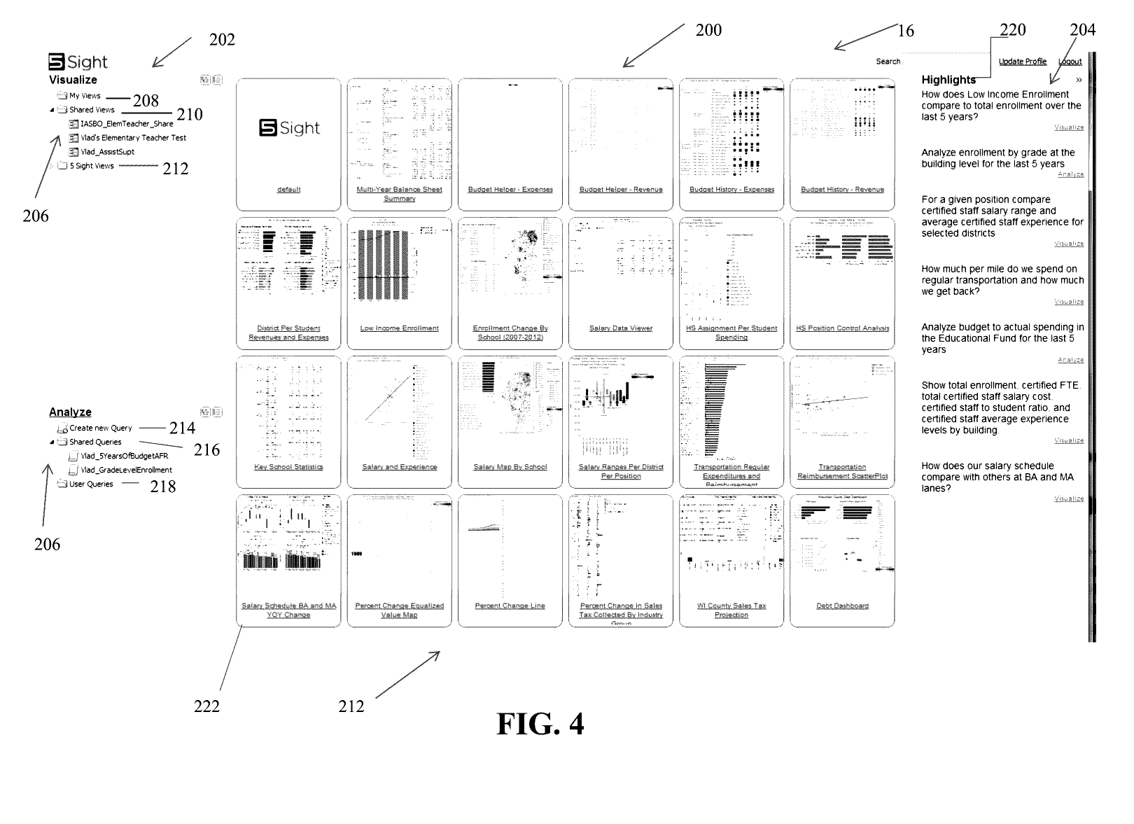

FIG. 4 illustrates a portion of an exemplary interface 200 of a visual portion of the review platform 16. The visual portion interface 200 may include a first sidebar 202 and a second sidebar 204. The first sidebar 202 may include one or more directories 206 that allow the user to navigate between the visual portion, the analysis portion, and the contents thereof. For example, under the “Visualize” directory 206, the user may navigate between saved visuals 208, shared visuals 210, and preconfigured visuals 212. The saved visuals 208, referred to as “My Views” in FIG. 4, may contain visuals that a user has previously saved. In other words, the user can save his or her favorite visuals of choice. The shared visuals 210, referred to as “Shared Views,” may contain visuals that the user has chosen to share with other users of the system. As described further below, these shared visuals 210 may be posted on a collaboration platform assigned to the user. The user may customize the appearance of his or her collaboration platform by dragging and dropping visuals into the shared visuals 210 directory. Preconfigured visuals 212 based on preconfigured datasets are discussed below.

Under the “Analyze” directory 206, the user may navigate between creating new queries 214, shared queries 216, and saved queries 218. If the user selects one of the options under the Analyze directory 206, the system may direct the user to the analysis portion of the review platform 16 as shown in FIGS. 2-3.

Further, the second sidebar 204 may display “Highlights” 220, some of which correspond to the visuals 212 that the system preconfigures and some of which correspond to preconfigured queries that the system configures. The Highlights 220 may be hypothetical questions, which are answered either by visuals 212 in the form of preconfigured graphical representations or by preconfigured queries. By clicking on the Highlights 220 that represent visuals 212, the system may direct the user to another section of the system where the visual 212 appears in full screen or near-full screen. By clicking on the Highlights 220 that represent preconfigured queries, the system may direct the user to the analysis portion of the review platform 16. The user may then alter the visual 212 or query as he or she sees fit.

The system 10 may generate the preconfigured visuals 212 and preconfigured queries based on preconfigured datasets. The system may engineer datasets based on optimal relationships between various data fields. In some embodiments, these preconfigured datasets may correspond to particular dimensions or even cubes of data within the multidimensional database. Some preconfigured datasets may be based on the most popular or most informative data that can be deduced from the database, for example. Other datasets may be engineered according to other logic, such as, for instance, a dataset where average teacher salary is bundled with the three data fields that have the strongest correlation to average teacher salary. Preconfiguring datasets expedites the process of querying the database and generating visuals 212.

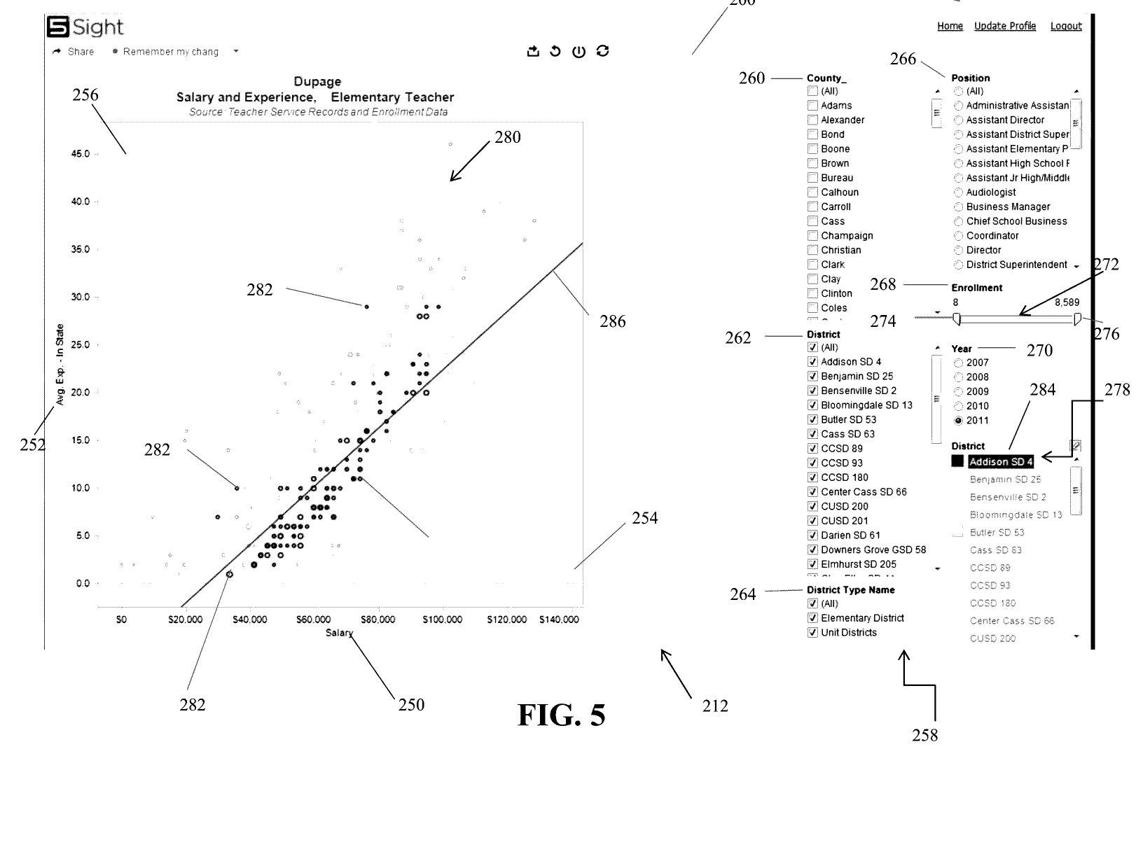

Referring now to FIG. 5, an exemplary visual 212 depicting salary 250 versus average in-state experience 252 is shown in the visual portion 200 of the review platform 102. This visual 212 may have been preconfigured by the system so that the user does not have to define input and measures. As with visuals that are generated from queries, the system may utilize a graphics engine like TABLEAU® Desktop and/or TABLEAU® Server to help generate the graphics for the visuals 212. Moreover, the units of salary 250 along an “X” axis 254 may be set to U.S. dollars, while the units of average experience 252 along a “Y” axis 256 may be set to years.

Also shown in FIG. 5 is a series of filters 258 that may allow users to select which data from the database are used as input for the visual 212. The filters 258 shown here include county 260, district 262, district type 264, position 266, enrollment 268, and year 270. In some embodiments, the filters 258 may be interdependent in that selections made within one filter 258 may affect the availability of options within another filter 258. For instance, Dupage County has been selected in the county filter 260, and therefore only those school districts within Dupage County are displayed within the district filter 262. Hence school districts from other counties are not displayed unless other counties are selected in addition to Dupage County. Within the district filter 262, the user may select “(All)” districts or may select certain districts for which the user wishes to display data in the visual 212.

Another filter 258 that may be provided is the enrollment filter 268, which involves a range bar 272. The user can manipulate the range bar 272 to define a range having a lower limit 274 and an upper limit 276. A user may wish to set the range to approximate the size of a school or schools within the user's district. Here, the lower limit 274 is set to eight students, and the upper limit 276 is set to 8,859 students. Thus, in generating the visual 212, the system did not use data from schools where enrollment is below eight students or above 8,859 students. Collectively, then, the filters 258 may cause the system to generate the visual 212 showing salary 250 versus average experience 252 based on the following: elementary teachers 266 from schools having between eight and 8,589 students 272, for all districts 262 and district types 264 within Dupage County 260 during the 2011 calendar year 270.

It should be understood that some of the principles described with respect to visuals 212 are similarly applicable to queries, and vice versa. For example, the interdependence of filters in some embodiments may be equally applicable to the configuration of queries. What's more, “visual” or “visuals” may in some embodiments be defined to include the filters 258 shown in FIG. 5.

Further, the visual portion of the review platform 16 may also include an accent pane 278. In this embodiment, the accent pane 278 allows the user to select which districts' data points 280 should be accented in the visual 212. In this example, the data points 282 corresponding to “Addison SD 4” 284 are shown in dark blue while all other data points 280 are shown in gray scale. Selecting more districts within the accent pane 278 may change the color of data points 280 corresponding to those districts from grayscale. In this way, a user can place emphasis on data points of particular interest.

Still another feature of the visual portion of the review platform 16 may involve fitting the data points 280 of the visual 212 with a linear regression line 286. The linear regression line 286 may be particularly helpful in the way of forecasting, as described below. Nonetheless, the linear regression line 286 may be computed by a least squares method, for example. The linear regression line 286 may represent the relationship between salary 250 and average experience 252 based on the data that has not been filtered. The linear regression line 286 may be shown in grayscale, conveying to the user that the line 286 corresponds to all unfiltered data (shown in gray scale) rather than the Addison SD 4 (shown in dark blue). On the other hand, the visual portion of the review platform 16 may include toggle buttons (not shown) so that a user may remove the linear transgression line 286 and/or add one or more linear regression lines specifically for the Addison SD 4, for other school districts, or for combinations of school districts. These linear regression lines may also be color coded in some embodiments.

The visual 212 may further be configured to display additional pieces of information when a user hovers a cursor (not shown) over a particular data point 280. In the context of this visual 212, for example, the information may indicate for a given data point 280 the name of the teacher, the school district, the school, the experience, the salary, and the student enrollment at that school.

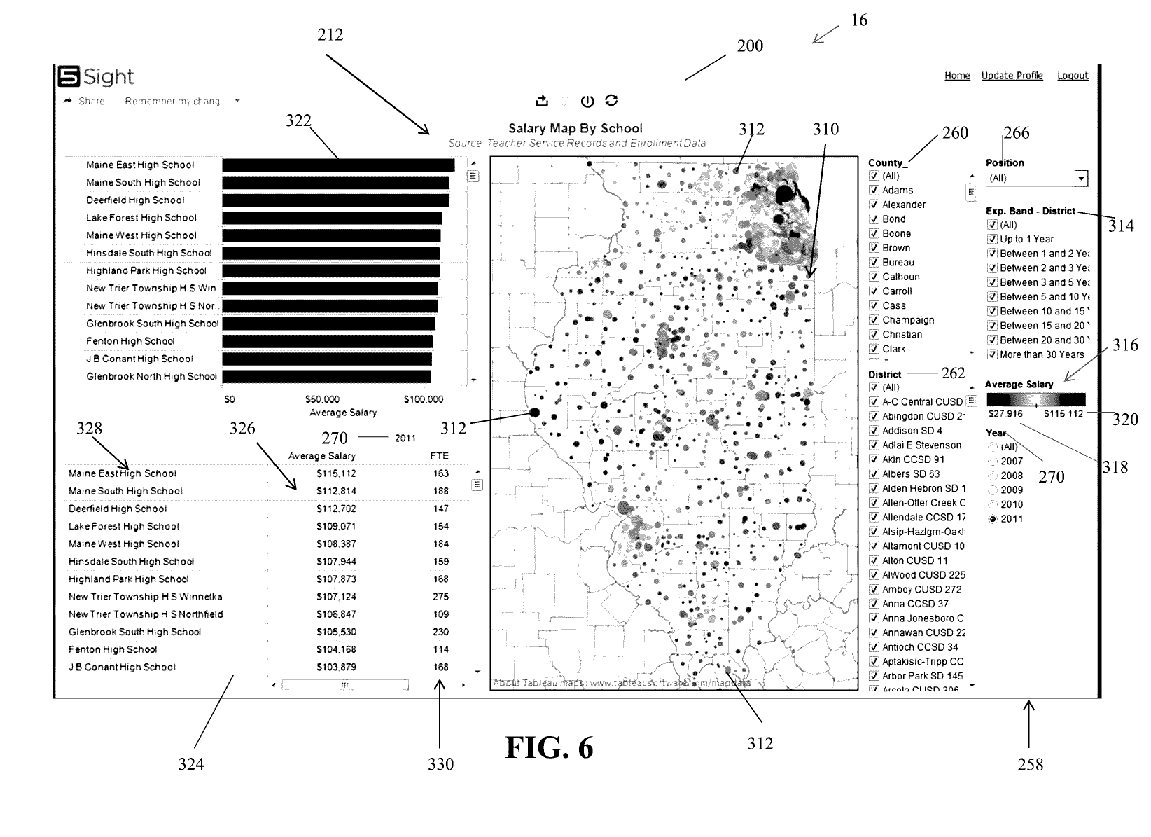

With respect now to FIG. 6, another exemplary visual 212 depicting average salaries by location 310 is shown in the visual portion of the review platform 16. Circles 312 representing the average salaries are placed on the visual 212 according to location 310 of schools. Diameters of the circles 312 may represent the number of FTE students for schools that correspond to locations on the visual 212. Further, the filters 258 allow the user to customize the visual 212 by selecting particular counties 260, districts 262, teacher positions 266, years 270, and ranges of experience 314. The user may customize the visual 212 by using interactive tools (not shown) to zoom, draw circles or boxes encompassing regions to filter in, out, and so on.

The visual 212 shown in FIG. 6 involves several additional features. For one, a legend 316 may indicate the relationship between average salary and color of dots on the visual 212. Based on the selected data, the legend 316 has a lower limit 318 of $27,916 and an upper limit 320 of $115,112. The legend 316 shows that circles 312 representing schools with an average salary closer to $27,916 are colored dark red on the visual 212. At the other end of the spectrum, circles 312 representing schools with an average salary closer to $115,112 are colored dark blue on the visual 212. Thus, based on the visual 212 here showing schools in Illinois, it is apparent that schools in the Chicagoland area have some of the highest paid teachers on average.

Another feature of the visual 212 may be a bar graph 322 depicting the average salaries of teachers at high schools that have not been filtered and are included as input. The schools may be sorted by average salary, from most-paid to least-paid. Yet another feature of the visual 212 may be a chart 324 showing specific values 326 of average salaries for each school 328 for the selected year 270. The chart 324 may also show other relevant statistics such as FTE count 330 for each school 328 for the selected year 270. Similar to the bar graph 322, the chart 324 may be sorted by average salary, from most-paid to least-paid.

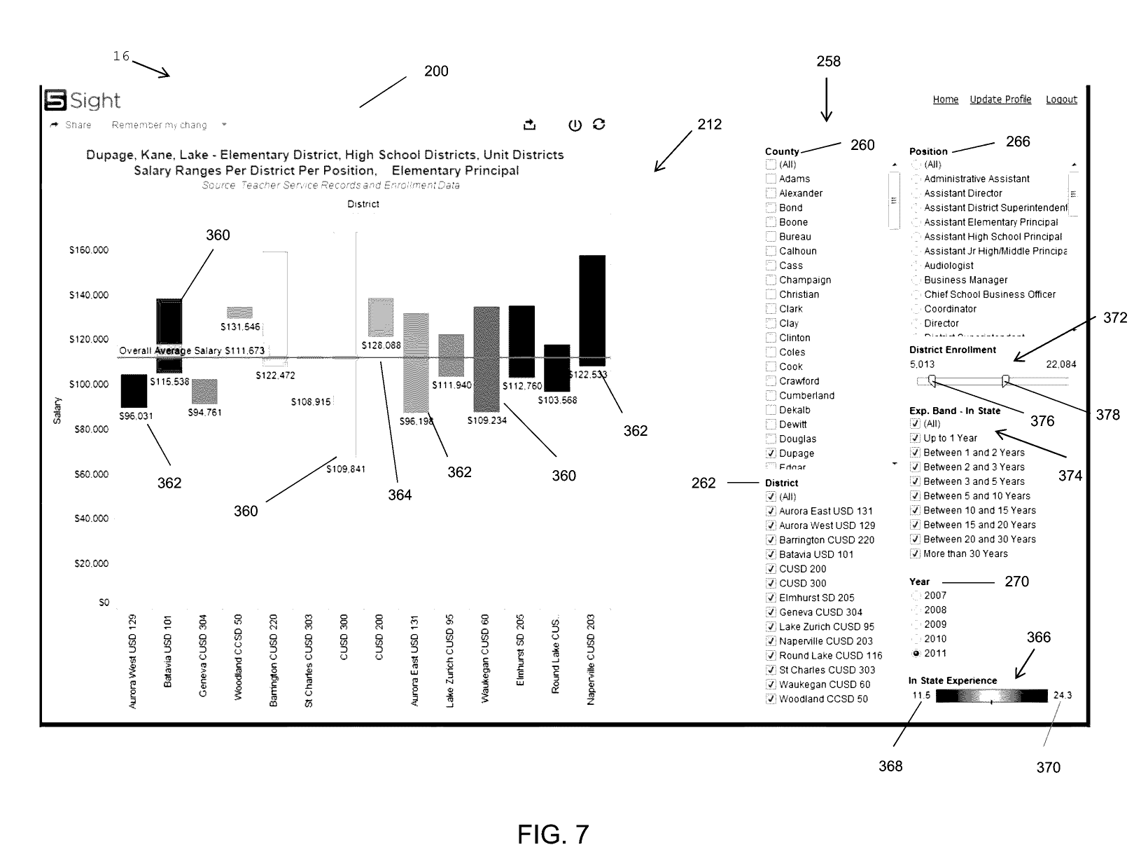

FIG. 7 shows still another visual 212, which represents salary ranges for elementary principals in school districts in Dupage County. In one embodiment, the visual 212 may include bars 360 that each represent a range of salaries for elementary principals within a school district. A number 362 beneath each bar 360 may represent the average salary. A horizontal line 364 may indicate the overall average salary for the data that the visual 212 represents. Further, the bars 360 may be color coded according to a legend 366 that indicates the average amount of in-state experience for the teachers represented by each bar 360. The legend 366 has a lower limit 368 and an upper limit 370. For the school districts represented in the visual 212, the least average experience for a school district is 11.5 years. On the other hand, the most average experience for a school district is 24.3 years, which corresponds to the bar 360 representing “Naperville CUSD 203” in dark blue. The bars 360 may be arranged on the visual 212 from the least amount of experience to the most.

FIG. 7 also shows the filters 258 that allow users to customize the visual 212. In particular, the filters 258 allow users to sort by county 260, district 262, position 266, year 270, district enrollment 372, and in-state experience bands 374. A district enrollment range bar 372 may include a lower limit 376 and an upper limit 378. Sliding the lower limit 376 and upper limit 378 may allow the user to filter the districts by number of students enrolled in a district. Further, the in-state experience band filter 374 may allow users to filter the data used to generate the visual 212 by level of experience.

FIGS. 4-7 illustrate merely three exemplary preconfigured visuals based on preconfigured datasets from the database. Without limitation, other exemplary preconfigured visuals may concern corporate personal property replacement tax percentage, revenue sources, multi-year balance sheet summary, budget expenses, budget revenue, historical budget expenses, historical budget revenue, district per student revenues and expenditures, high school position control analyses, key school statistics, salary survey year-to-year changes, transportation expenditures and reimbursement, percent changes, sales tax projections, and debt trackers.

Other features of the visual portion of the review platform 16 may include features to generate an image file (e.g., JPEG or GIF) based on the customized visual 212, to generate a PDF based on the customized visual 212 or the entire visual portion 200, to export the data that is used for a particular visual 212 after filtering and customizing, and to update saved visuals 212 based on new data, for example. To reiterate, it should be understood that this list—along with other lists described herein—are merely exemplary.

Referring again to FIG. 1, another aspect of the system 10 may be the forecasting platform 18. The forecasting platform 18 may enable users to analyze multiple complex, forward-looking scenarios. In some embodiments, the forecasting platform 18 may retrieve data from the database 18. In still further embodiments, users of the system may supply their own data from which the system can analyze trends and generate projections.

Exemplary projections that may be provided through the forecasting platform include, without limitation, how much money to allocate for elementary school payroll over the next five years, what live birth rates will be for the next three years, or how low income student population will grow in the next fifteen years. Further, the server 12 may accept user input of one or more variables that impact these projections of the forecasting platform 18. Taking the first example, for instance, the user may wish to project elementary school payroll over the next five years, but the user may also wish to factor in a fifteen percent increase in class size for his or her school district over the next five years. The system 10, then, may identify salaries and other constituent costs that contribute to elementary school payroll. The system 10 may also identify data fields that have a strong correlation with such costs, salaries, and elementary school payroll generally. Using the input from the user, strongly correlated data, data from the user's own school district, and other tools such as linear regression lines that represent relationships amongst data fields, the system 10 may generate a projection concerning how much to allocate for five years' worth of elementary school payroll. As with other platforms and aspects of the system, the user may then save the projection and compare it with other projections or with projections of other users.

With the multitude of resources and analytics provided by the system and as described with respect to the review platform 16 and the forecasting platform 18, users may wish to share this information with others. Likewise, users may wish to look to information that others feel is worth sharing.

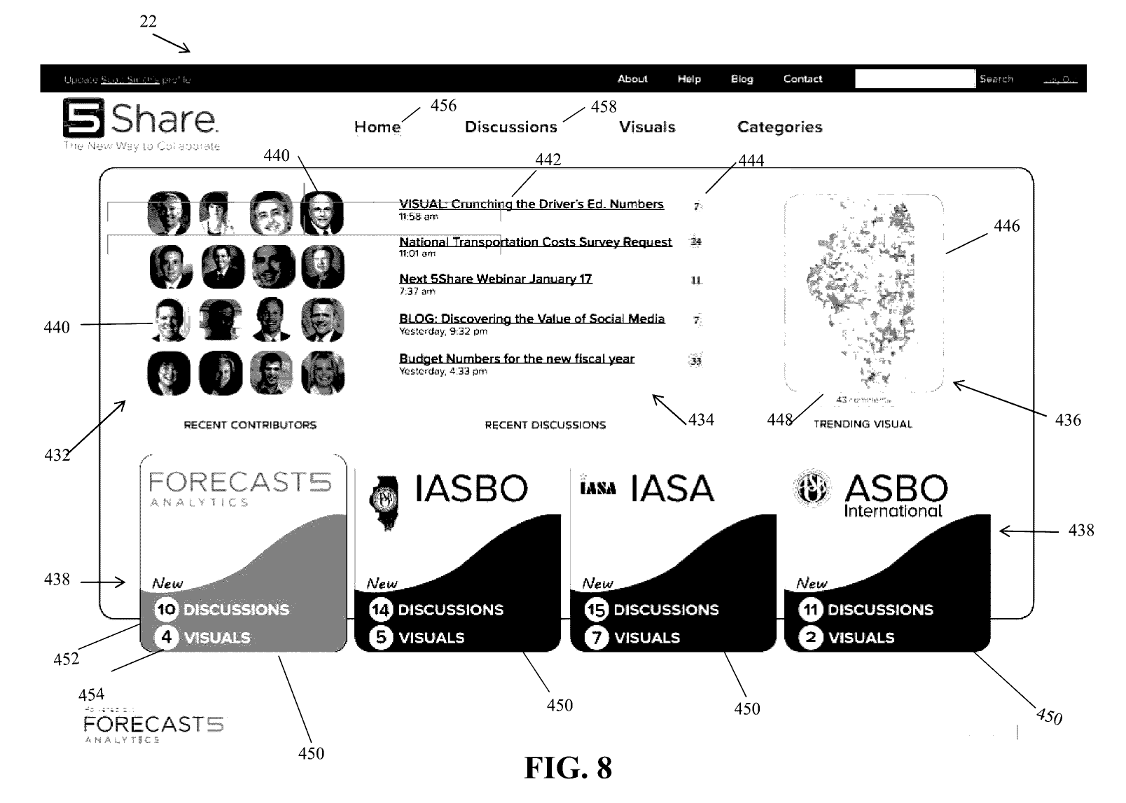

With reference now to FIG. 8, the system 10 may provide users with a collaboration platform 20 where each user has a customizable homepage. In general, the collaboration platform 20 allows users to communicate and share ideas with one another. In some embodiments, users can distribute data, share lessons learned, survey other municipalities, review articles, blog with colleagues, share ideas, publish visualizations, search for solutions, identify best practices, and the like on their homepages. Users can even join groups and address the same problem or similar problems as a group. For example, users can establish or join a peer group and identify key performance indicators by determining which factors are driving the performance of industry leaders. The collaboration platform may additionally provide users updates (for example, via email) regarding trending discussions and topics, including discussions and topics related to the groups which the user has joined or participated in.

In the embodiment shown in FIG. 8, a portion of the user interface 430 of the collaboration platform may include sections on recent contributors 432, recent discussions 434, trending visual 436, and favorites 438. The recent contributors section 432 may include thumbnail images 440 of users of the system that have made the most contributions over the last week or month. Clicking on one of the thumbnail images 440 may direct the user to the homepage that corresponds to the individual shown in that particular thumbnail image 440. The user may then review that contributor's most recent contributions.

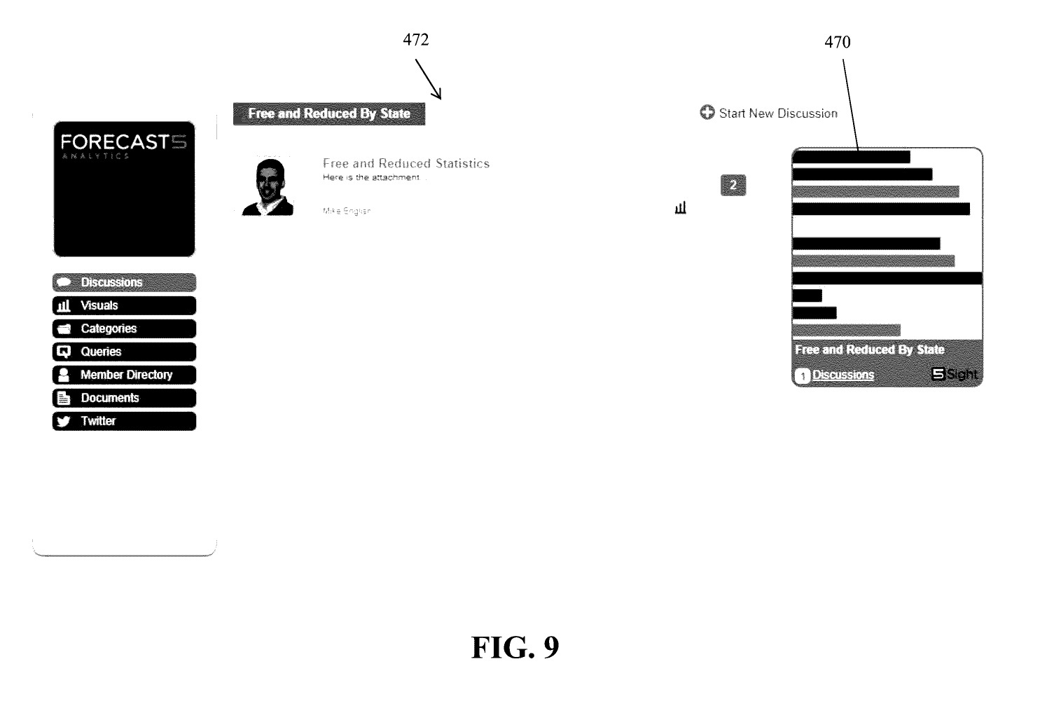

The recent discussions section 434 on the collaboration platform may show headlines 442 corresponding to the most recent discussions occurring via the system. Each headline 442 may have a numeral 444 that represents that number of posts by users within the discussion associated with each headline 442. By clicking one of the headlines 442, a user may be directed to the relevant discussion (see FIG. 9). Further, the trending visual section 436 may include at least one thumbnail 446 of a visual that has received the most attention from users of the system within the last week, month, or the like. Users may click the thumbnail 446 to explore the visual and join the discussion. A numerical indicator 448 may inform users of how many comments have been made with respect to the particular visual.

The favorite section 438 of the collaboration platform 20 may provide an area in which a user can display thumbnails 450 that correspond to the user's favorite groups, for example. Each thumbnail 450 may include indicators 452, 454 corresponding to numbers of discussions and visuals, respectively, within each group.

The collaboration platform 20 may further include headers corresponding to a homepage 456, a discussions page 458, a visuals page 460, and a categories page 462. The discussions page 458 may contain a comprehensive listing of discussions that have occurred via the system. A user may be able to browse discussions by heading or search discussions based on keywords, dates, contributors, and the like. The visuals page 460 may contain visuals that other users have shared on the collaboration platform 430. Similar to the discussions page 458, the user may search the visuals page 460 by keywords, dates, contributors, and the like or browse by topic. Further, the categories page 462 may provide a space where users can search visuals and discussions by category. For example, users may be interested in learning about what other users are saying and sharing with regard to salaries of elementary school principals, tax cuts, or long term debt, for instance. Still other links 464 allow users to learn “about” the system, to seek “help” regarding the system, to “blog” about current issues, to “contact” other users, and to “search” the system for particular content.

The collaboration platform 22 may enable users to have data-centric discussions, in an embodiment. For example, a user may wish to discuss a particular aspect of a school district, a comparison of neighboring school districts, a trend in enrollment or demographics, or any other topic relevant to the user's business interest. FIG. 9 illustrates another exemplary portion of the user interface 430 of the collaboration platform 20. As shown in FIG. 9, the collaboration platform 22 may show one or more visuals 470 and list of associated discussions 472. Thus, the collaboration platform 22 may provide for a number of different discussions for a single visual or data set, and may compile them into a single list for easy reference by users.

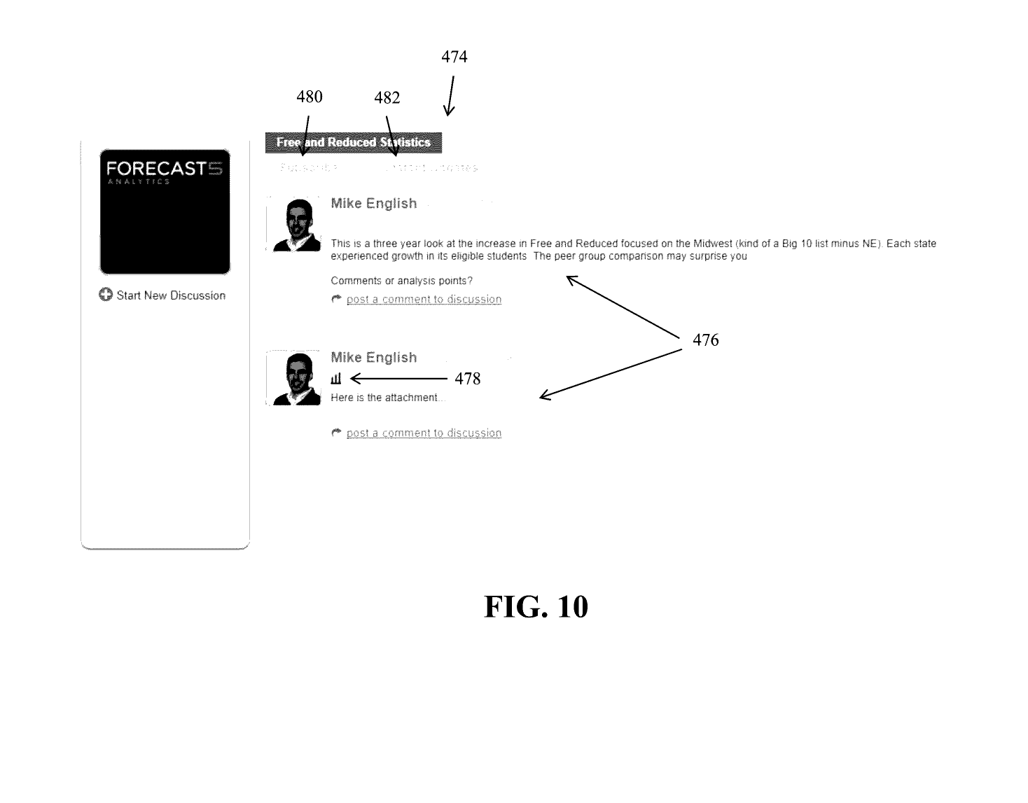

FIG. 10 illustrates an interface for a particular discussion 474 associated with the visual 470 of FIG. 9. Within the discussion, one or more users may place their thoughts and contributions to the discussion in respective posts 476. One or more of the posts 476 may include a link 478 to an underlying visual or dataset. The discussion interface may additionally provide functionality for a user to subscribe 480 to the discussion (e.g., via an RSS feed) and/or to receive updates 482 when new posts are made in a discussion (e.g., via email).

Referring to FIGS. 1 and 10, the link 478 to underlying visual or data set may link to another platform on the system 10, such as the review platform 16, for example. Thus, a user of the collaboration platform 22 may refer to data stored in the database 14 (and/or a visual based on that data). As a result, posting a link 478 to a visual or data in the collaboration platform 22 may allow other users to examine the data and visuals to which the posting user refers. Furthermore, because the link may direct to the review platform 16, users may alter the inputs for a visual, for example, to provide new insights to the discussion 474. Those users may then post a link to a new visual or data set to the discussion 474.

The collaboration platform 22 thus enables a unique, data-driven collaboration environment in which users may work from a common data set to provide insights to a discussion. The collaboration platform 22 thus provides an improvement over known social networking and collaboration environments, in which users are not provided easy access to data to drive the discussion, and in which multiple users generally are not able to work from a common data source.

Referring again to FIG. 1, the system 10 may further include a consultation platform 22 that allows users to connect with professionals having expertise in the subject matter to which the database 14 pertains. The professionals may be familiar with the database 14 and system 10, and therefore may be able to provide advice based on significant experience with the database 14 and system 10. For example, the professionals may be able to advise users on visuals or queries that may be particularly helpful to a user's issues. Or the professional may be able to best interpret a trend derived from the forecasting platform 18.

It will be appreciated that in addition to the structures of the disclosed system 10 described above, another aspect of the present disclosure involves the methodologies of the system 10. It will be further appreciated that the methodologies and constituent steps thereof that may be performed and carried out by the system 10, which were described in great detail above, apply to this aspect of the disclosure with equal force. Therefore, the description of the methodologies as set forth above with respect to the system will not be repeated in full.

Several steps of methods for utilizing the system may involve aggregating business data from a multitude of sources, whether private or public, and organizing that business data in a comprehensive database or in a series of databases. The methods may also include configuring datasets and corresponding queries and visuals based on the most-popular or most-insightful data, for example, in the database. In some embodiments, the datasets may be configured prior to any user input, as noted above. Further, the methods may include retrieving data from the database at users' requests and updating the database periodically. Still further, the methods may involve a step of forecasting based on at least one of the following: aggregated business data and user input. In some embodiments, the methods may also involve providing users with a platform in which they can collaborate to share queries and visuals, exchange ideas, discuss hot topics, and so on.

While the disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

What is claimed is:

1. A system for analyzing business data, the system comprising:
a database in which business data is aggregated;
a processor configured to execute computer code to provide a graphical user interface comprising visuals and queries;
an analysis platform configured to allow users to choose content for the visuals and the queries of the graphical user interface;
a forecasting platform configured to compute projections based on at least one of user input and the business data in the database; and
a collaboration platform configured to allow users to share information related to the business data with one another.

2. The system of claim 1, wherein the business data comprises financial data related to municipalities managing schools.

3. The system of claim 1, wherein the database comprises a multidimensional database.

4. The system of claim 1, wherein the database comprises a relational database.

5. The system of claim 1, wherein the database is a first, relational database, further comprising a second, multidimensional database containing business data, wherein the business data of the second, multidimensional database is used to generate visuals and respond to queries in the analysis platform.

6. The system of claim 1, wherein the analysis platform is configured to allow users to choose content for the visuals and the queries of the graphical user interface based on the business data in the database.

7. The system of claim 1, wherein the collaboration platform comprises a discussion portion in which a user may post a visual for discussion based on the business data in the database and comments on the visual for discussion.

8. The system of claim 7, wherein the collaboration platform discussion portion is configured to provide a user a link to the data underlying the visual for discussion.

9. The system of claim 8, wherein the collaboration platform discussion portion is configured to allow a second user to post a second, different visual for discussion based on the data underlying the visual for discussion.

10. The system of claim 1, wherein the processor is further configured to accept data from a user and store the data in the database.

11. A method for analyzing business data, the method comprising:
aggregating business data;
organizing the business data into a database;
retrieving a dataset from the database based on a request from a user;
displaying a visual based on the dataset on a graphical user interface;
forecasting projections based on at least one of user input and the business data from the database; and
providing the user with a collaboration platform that allows the user to share information related to the dataset with other users.

12. The method of claim 11, wherein the business data comprises financial data related to municipalities managing schools.

13. The method of claim 11, wherein the database comprises a multidimensional database.

14. The method of claim 11, wherein the database comprises a relational database.

15. The method of claim 11, further comprising providing an interface including thumbnails of a plurality of visuals based on respective datasets and displaying a full visual responsive to a user selection of an associated thumbnail.

16. The method of claim 11, further comprising accepting user input to filter the dataset through the graphical user interface.

17. The method of claim 11, wherein the collaboration platform comprises a discussion portion in which a user may post a visual for discussion based on the business data in the database and comments on the visual for discussion.

18. The method of claim 17, wherein the collaboration platform discussion portion is configured to provide a user a link to the data underlying the visual for discussion.

19. The method of claim 18, wherein the collaboration platform discussion portion is configured to allow a second user to post a second, different visual for discussion based on the data underlying the visual for discussion.

20. The method of claim 11, wherein the business data is aggregated from public sources.
